(19) United States
(12) Patent Application Publication
(10) Pub. No.: US 2007/0207016 A1
(43) Pub. Date: Sep. 6, 2007

(54) Stocker and floor system

(75) Inventor: Masanao Murata, Mie (JP)

Correspondence Address: DRINKER BIDDLE & REATH (DC), 1500 K STREET, N.W., SUITE 1100, WASHINGTON, DC, 20005-1209, US

(73) Assignee: ASYST SHINKO, INC.

(21) Appl. No.: 11/712,566

(22) Filed: Mar. 1, 2007

(30) Foreign Application Priority Data
Mar. 2, 2006 (JP) 2006-056083

(51) Int. Cl. B65G 1/00

(52) U.S. Cl. 414/281

(57) ABSTRACT

A floor system is adapted to arrange, above a floor, a housing that can store plural cassettes, each of which is capable of storing plural articles, an article processor for processing each of the articles, and a stacker crane for transferring each of the cassettes between the housing and the article processor. In the floor system, a first floor component is located between the floor and each of the housing and the stacker crane. A second floor component is adjacent to but separate from the first floor component and is located between the floor and the article processor.

The disclosure of Japanese Patent Application No. 2006-056083 filed Mar. 2, 2006 including specification, drawings and claims is incorporated herein by reference in its entirety.

### BACKGROUND

The present invention relates to a stocker which temporarily stores a cassette or the like which accommodates therein an accommodated article and includes an accommodated article processing unit for performing a manufacturing. operation such as inspection on the accommodated article.

Conventionally, in a manufacturing plant such as a semiconductors manufacturing plant or a liquid crystal display panels manufacturing plant, a cassette which accommodates an accommodated article (for example, a processing object such as a semiconductor substrate or liquid crystal display glass substrate, a photomask glass substrate, and an optical disk substrate), is temporarily stored in a stocker while it is transferred from one manufacturing step to another manufacturing step in a manufacturing process. Namely, the cassette is transferred to a shelf in the stocker by a stacker crane provided in the stocker for temporary storage.

Japanese Patent Publication No. 2006-21913 discloses a stocker which is configured such that an interior thereof is filled with clean dry air from which molecular pollutant is removed to be 10 ppb or less and whose atmospheric dew point is −100° C. or lower in order to prevent the adhesion of harmful matters such as water to the accommodated article during storage to ensure the prevention of device failure attributed to charging.

In addition, in recent years, there has been proposed a technique in which a manufacturing operation such as inspection or working is performed on an accommodated article accommodated in a cassette in a stocker by making use of storage time during which the cassette is stored in the stocker.

However, when the manufacturing operation is performed on the accommodated article accommodated in the cassette in the stocker, since vibrations generated when the stacker crane transfers the cassette are transmitted to the accommodated article processing unit for processing the accommodated article, there is caused a problem that the processing of the accommodated article is badly affected.

### SUMMARY

An object of the invention is to provide a stocker which can implement preferably the processing of an accommodated article.

According to the invention, there is provided a stocker including a storing unit for storing therein an accommodating unit which accommodates therein an accommodated article, an accommodated article processing unit for performing a manufacturing operation on the accommodated article within the accommodating unit, and a transfer unit for transferring the accommodating unit between the storing unit and the accommodated article processing unit, wherein the storing unit and the transfer unit are placed on a primary floor plate, and wherein the accommodated article processing unit is placed on a secondary floor plate which is independent of the primary floor plate.

According to the configuration that has been described above, since the accommodated article processing unit is placed on the secondary floor plate which is independent of the primary floor plate on which the storing unit and the transfer unit are placed, vibrations generated when the transfer unit transfers the accommodating unit are prevented from being transmitted to the accommodated article processing unit. Therefore, the processing of the accommodated article by the accommodated article processing unit can be implemented preferably.

In the stocker of the invention, the primary floor plate may be supported by a primary floor, and the secondary floor plate may be supported by a secondary floor which is independent of the primary floor. According to this configuration, since the secondary floor plate on which the accommodated article processing unit is placed is supported by the secondary floor which is independent of the primary floor which supports the primary floor plate on which the storing unit and the transfer unit are placed, vibrations generated when the transfer unit transfers the accommodating unit can more preferably be prevented from being transmitted to the accommodated article processing unit.

In the stocker of the invention, the secondary floor plate may be supported by a vibration control unit. According to this configuration, since the secondary floor plate on which the accommodated article processing unit is placed is supported by the vibration control unit, vibrations generated when the transfer unit transfers the accommodating unit can more preferably be prevented from being transmitted to the accommodated article processing unit by the vibration control unit.

According to the invention, there is provided a stocker including a storing unit for storing therein an accommodating unit which accommodates therein an accommodated article, an accommodated article processing unit for performing a manufacturing operation on the accommodated article within the accommodating unit, and a transfer unit for transferring the accommodating unit between the storing unit and the accommodated article processing unit, wherein the storing unit and the transfer unit are placed on a floor plate, and wherein the accommodated article processing unit is placed on a vibration control unit which is independent of the floor plate.

According to the configuration that has been described above, since the accommodated article processing unit is placed on the vibration control unit which is independent of the floor plate on which the storing unit and the transfer unit are placed, vibrations generated when the transfer unit transfers the accommodating unit can be prevented from being transmitted to the accommodated article processing unit. Consequently, the processing of the accommodated article by the accommodated article processing unit can preferably be implemented.

According to the invention, there is also provided a floor system adapted to arrange, above a floor, a housing that can store plural cassettes, each capable of storing plural articles, an article processor for processing each of the articles, and a stacker crane for transferring each of the cassettes between the housing and the article processor, the floor system comprising:

a first floor component that is located between the floor and each of the housing and the stacker crane; and

a second floor component that is adjacent to but separate from the first floor component and that is located between the floor and the article processor.

The first floor component may include:
plural first supporting legs provided on and erecting from the floor; and
at least one first floor plate supported by the first supporting legs,
   wherein the at least one first floor plate defines a first surface where the housing and the stacker crane are disposed.

The second floor component may include:
plural second supporting legs that are different from the first supporting legs and that are provided on and erect from the floor; and
at least one second floor plate that is different from the first floor plate and that is supported by the second supporting legs,

wherein the at least one second floor plate defines a second surface where the article processor is disposed.

The second floor component may include:
a secondary floor that is located above the floor and that is independent of the floor;
plural second supporting legs that are different from the first supporting legs and that are provided on and erect from the secondary floor; and
at least one second floor plate that is different from the first floor plate and that is supported by the second supporting legs,

wherein the at least one second floor plate defines a second surface where the article processor is disposed.

The second floor component may include:
a block that is provided on a tertiary floor located below the floor;
plural second supporting legs that are different from the first supporting legs and that are provided on and erect from the block; and
at least one second floor plate that is different from the first floor plate and that is supported by the second supporting legs,

wherein the at least one second floor plate defines a second surface where the article processor is disposed.

The second floor component may include:
an anti-vibration unit provided on the floor;
plural second supporting legs that are different from the first supporting legs and that are provided on and erect from the anti-vibration unit; and
at least one second floor plate that is different from the first floor plate and that is supported by the second supporting legs,

wherein the at least one second floor plate defines a second surface where the article processor is disposed.

The second floor component may include:
a block that is provided on a tertiary floor located below the floor;
plural second supporting legs that are different from the first supporting legs and that are provided on and erect from the block; and
at least one second floor plate that is different from the first floor plate and that is supported by the second supporting legs,

wherein the at least one second floor plate defines a second surface where the article processor is disposed.

The second floor component may include:
an anti-vibration unit provided on the floor;
plural second supporting legs that are different from the first supporting legs and that are provided on and erect from the anti-vibration unit; and
at least one second floor plate that is different from the first floor plate and that is supported by the second supporting legs,

wherein the at least one second floor plate defines a second surface where the article processor is disposed.

The second floor component may include:
an anti-vibration unit provided on the floor,

wherein the anti-vibration unit defines a second surface where the article processor is disposed.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a perspective view of a stocker;

FIG. 2 is an explanatory drawing of a floor plate;

FIG. 3 is a side view showing the stocker, floor plates and a floor;

FIG. 4 is a side view showing a stocker, floor plates and floors;

FIG. 5 is a side view showing a stocker, floor plates and floors;

FIG. 6 is a side view showing a stocker, floor plates and a floor; and

FIG. 7 is a side view showing a stocker, a floor plate and a floor.

### DETAILED DESCRIPTION OF THE EMBODIMENTS

Hereinafter, embodiments of stockers according to the invention will be described by reference to the accompanying drawings.

### First Embodiment

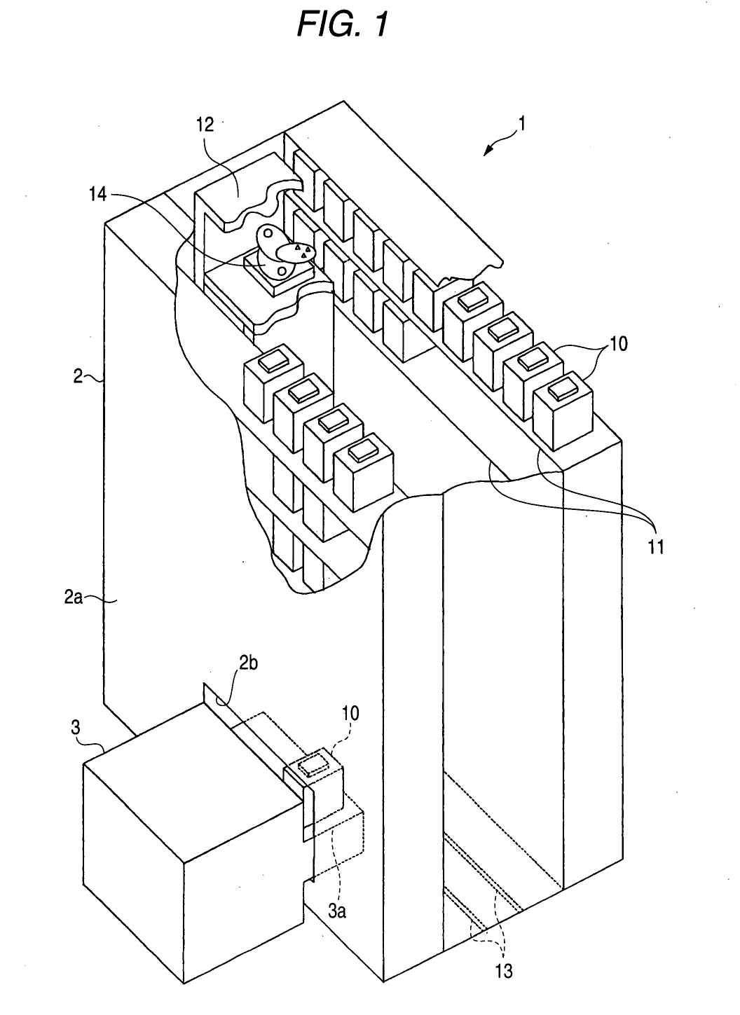

Firstly, referring to FIGS. 1 to 3, a first embodiment of the invention will be described.

(Configuration of Stocker 1)

As is shown in FIG. 1, a stocker 1 includes shelves 11, functioning as a storing unit, which are arranged in a multiplicity of stages so that a plurality of cassettes 10, functioning as a storing unit, can be placed thereon and a housing 2 which includes a stacker crane 12 functioning as a transfer unit for transferring the cassettes 10 in an interior thereof. The stacker crane 12 moves in a longitudinal direction on rails 13 which are provided on a bottom surface of the stocker 1 so as to transfer a cassette 10 placed at a carry-in port, not shown, to the shelf 11 and transfer a cassette 10 placed on the shelf 11 to a carry-out port, not shown, by exploiting a stacker robot 14.

In addition, an insertion port 2b is formed in a side surface 2a of the housing 2, so that an inspection table 3a of an inspection unit 3 as an accommodated article processing unit is inserted into the interior of the housing 2. When a cassette 10 placed on the shelf 11 is transferred on to the inspection table 3a by the stacker crane 12, the inspection unit 3 performs an inspection on a wafer (not shown) which is an accommodated article within the cassette 10. Then, when the inspection is completed, the cassette 10 on the inspection table 3a is transferred back to the shelf 11 by the stacker crane 12. Note that while in this embodiment, the inspection unit 3 which performs an inspecting operation on a wafer is described as the accommodated article processing unit, the accommodated article processing unit may be such as to perform photolithography or other processings.

(Configuration of Floor)

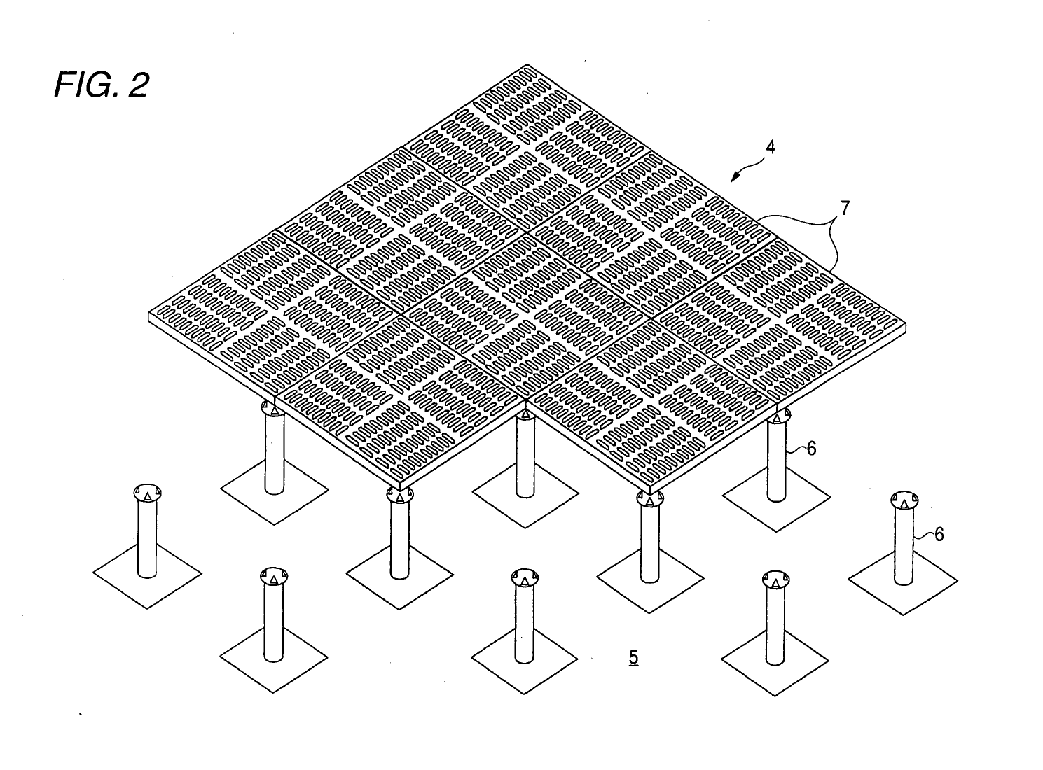

As is shown in FIG. 2, a floor plate 4 on which the housing 2 and the inspection unit 3 are placed is made up of a plurality of panels 7 which are supported by a plurality of supporting legs 6 which are provided on a floor 5 in such a manner as to erect therefrom. In a clean room provided on a first floor, the floor 5 is made of concrete which is spread over the ground, and in a clean room provided on a second floor or higher, the floor 5 is made up of a floor which constitutes a partition between a floor and a floor directly thereabove or therebelow. In addition, as the panels 7, grating panels, punching panels, shield panels and the like can be raised. The plurality of supporting legs 6 are provided longitudinally and transversely at equal intervals, and four projections formed on an upper surface of each supporting leg 6 are normally made to be fitted in different panels 7 individually. Namely, one panel 7 is supported by four supporting legs 6. In other words, normally, one supporting leg 6 supports four panels 7 individually at one corner thereof.

(Configuration of Floor of the Embodiment)

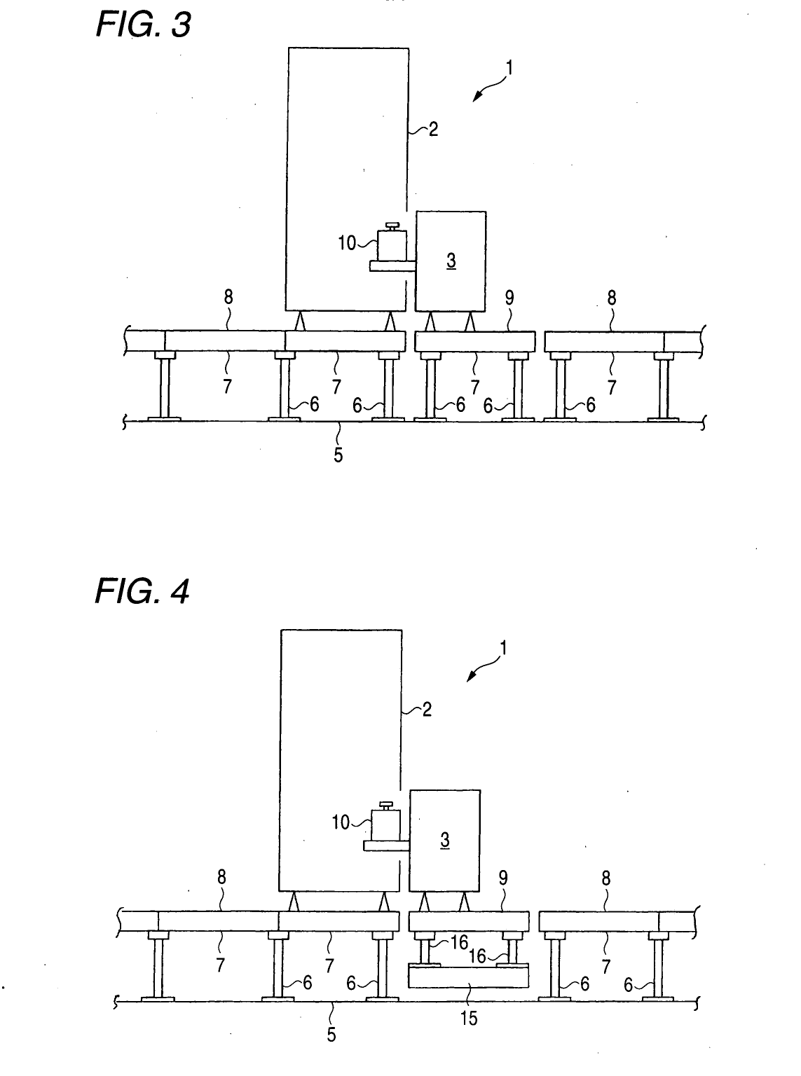

As is shown in FIG. 3, the housing 2 which includes the shelves 11 and the stacker crane 12 is placed on a primary floor plate 8, while the inspection unit 3 is placed on a secondary floor plate 9 which is independent of the primary floor plate 8. The primary floor plate 8 and the secondary floor plate 9 are each made up of a plurality of panels 7. While the primary floor plate 8 and the secondary floor plate 9 are both supported by a plurality of supporting legs 6 which are provided on the floor 5 in such a manner as to erect therefrom, the panels 7 which make up the primary floor plate 8 and the panels 7 which make up the secondary floor plate 9 are spaced apart from each other. Consequently, while there may occur a case where vibrations which are generated due to the stack crane 12 moving on the rails 13 to transfer a cassette 10 are transmitted to the primary floor plate 8, then transmitted to the floor 5 via the supporting legs 6, then transmitted to the secondary floor plate 9 via the supporting legs 6 and finally transmitted to the inspection unit 3, there occurs no case where the inspection unit 3 is vibrated as a result of direct transmission of the vibrations so generated from the primary floor plate 8 to the secondary floor plate 9, whereby the transmission of the vibrations which are generated when the stacker crane 12 transfers the cassette 10 to the inspection unit 3 can be suppressed.

(Operation of Stocker 1)

The operation of the stocker 1 will be described by reference to FIGS. 1 and 3. The stacker crane 12 transfers a cassette 10 placed on the shelf 11 to the inspection table 3a of the inspection unit 3. The inspection unit 3 performs an inspection on a wafer inside the cassette 10 placed on the inspection table 3a. Even during which the inspection unit 3 is performing the inspection, the stacker crane 12 moves on the rails 13 to transfer a cassette 10 placed on a carry-in port, not shown, to the shelf 11 or transfer a cassette 10 on the shelf 11 to a carry-out port, not shown. Although vibrations are generated due to the stacker crane 12 moving on the rails 13 to transfer the cassette 10 in such a way, since the primary floor plate 8 on which the housing 2 which includes the stacker crane 12 is placed is independent of the secondary floor plate 9 on which the inspection unit 3 is placed, there occurs no case where the vibrations so generated are transmitted from the primary floor plate 8 directly to the secondary floor plate 9, whereby the transmission of the vibrations generated when the stacker crane 12 transfers the cassette 10 to the inspection unit 3 is suppressed. Consequently, the inspection of the wafer by the inspection unit 3 can preferably be performed.

(Summary of the Embodiment)

As has been described heretofore, the stocker 1 of this embodiment includes the shelves 11 which store cassettes 10 each accommodating therein a wafer, the inspection unit 3 for performing the manufacturing operation (inspection) on the wafers in the cassettes 10, and the stacker crane 12 for transferring the cassettes 10 between the shelves 11 and the inspection unit 3, and the shelves 11 and the stacker crane 12 are placed on the primary floor plate 8, while the inspection unit 3 is placed on the secondary floor plate 9 which is independent of the primary floor plate 8.

According to the configuration that has been described heretofore, since the inspection unit 3 is placed on the secondary floor plate 9 which is independent of the primary floor plate 8 on which the shelves 11 and the stacker crane 12 are placed, the transmission of vibrations generated when the stacker crane 12 transfers the cassettes 10 to the inspection unit 3 can be suppressed. Consequently, the processing (inspection) of the wafers by the inspection unit 3 can preferably be performed.

### Second Embodiment

Next, referring to FIGS. 1 and 4, a second embodiment of the invention will be described below.

(Configuration of Floor of the Embodiment)

The second embodiment differs from the first embodiment in that a secondary floor plate 9 on which an inspection unit 3 is placed is, as is shown in FIG. 4, supported by supporting legs 16 which are provided on a secondary floor 15 which is independent of a floor (a primary floor) 5 which supports a primary floor plate 8 in such a manner as to erect therefrom. The secondary floor 15 is made up of floor joist steels or H steels, square pipe steels and the like and is connected to pillars or the like, not shown.

While vibrations generated due to a stacker crane 12 moving on rails 13 to transfer cassettes 10 are transmitted to the primary floor plate 8 and then to the floor 5 via supporting legs 6, since the floor 5 and the secondary floor 15 are independent of each other, there occurs no case where the vibrations are transmitted from the floor 5 to the secondary floor 15 and then to the inspection unit 3. In addition, there also occurs no case where the inspection unit 3 is vibrated by the vibrations which are transmitted from the primary floor plate 8 directly to the secondary floor plate 9.

(Operation of Stocker 1)

The operation of a stocker 1 will be described using FIGS. 1 and 4. Even during which the inspection unit 3 is performing an inspection, the stacker crane 12 moves on the rails 13 to transfer cassettes 10. Although vibrations are generated due to the stacker crane 12 moving on the rails 13 to transfer the cassettes 10, since the primary floor plate 8 on which a housing 2 which includes the stacker crane 12 is placed is independent of the secondary floor plate 9 on which the inspection unit 3 is placed, there occurs no case where the vibrations so generated are transmitted from the primary floor plate 8 directly to the secondary floor plate 9. In addition, since the floor 5 which supports the primary floor plate 8 is independent of the secondary floor 15 which supports the secondary floor plate 9, there also occurs no case where the vibrations so generated are transmitted from the floor 5 to the secondary floor 15 to thereby vibrate the inspection unit 3. By this configuration, the transmission of vibrations generated when the stacker crane 12 transfers the cassettes 10 to the inspection unit 3 can more preferably be suppressed, thereby making it possible to allow the inspection unit 3 to inspect wafers more preferably.

(Summary of the Embodiment)

As has been described heretofore, in the stocker 1 of this embodiment, the configuration is adopted in which the primary floor plate 8 is supported by the floor (the primary floor) 5, while the secondary floor plate 9 is supported by the secondary floor 15 which is independent of the floor 5. According to the configuration, since the secondary floor plate 9 on which the inspection unit 3 is placed is supported by the secondary floor 15 which is independent of the floor 5 which supports the primary floor plate 8 on which shelves 11 and the stacker crane 12 are placed, the transmission of the vibrations generated when the stacker crane 12 transfers the cassettes 10 to the inspection unit 3 can more preferably be suppressed.

### Third Embodiment

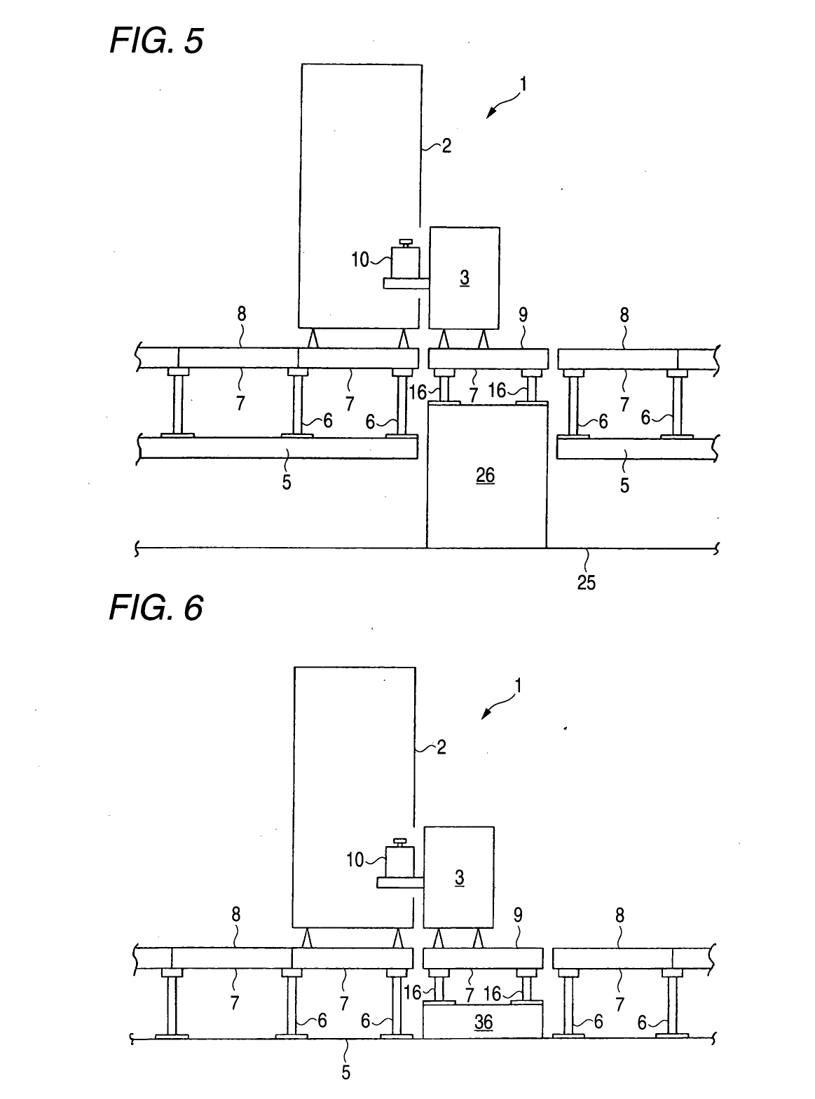

Next, referring to FIGS. 1 and 5, a third embodiment of the invention will be described below.

(Configuration of Floor of the Embodiment)

The third embodiment differs from the first embodiment in that a secondary floor plate 9 on which an inspection unit 3 is placed is, as is shown in FIG. 5, supported by supporting legs 16 which are provided on a block 26 in such a manner as to erect therefrom. The block 26 is made up of a steel framed reinforced concrete construction or the like and is provided on a tertiary floor 25 such as a solid ground or a floor of a storey below in such a manner as to erect therefrom.

While vibrations generated due to a stacker crane 12 moving on rails 13 to transfer cassettes 10 are transmitted to a primary floor plate 8 and then to a floor 5 via supporting legs 6, since the floor 5 and the tertiary floor 25 are independent of each other, there occurs no case where the vibrations so generated are transmitted from the floor 5 to the tertiary floor 25 to thereby vibrate an inspection unit 3. In addition, there also occurs no case where the vibrations so generated are transmitted from the primary floor plate 8 directly to a secondary floor plate 9 to thereby vibrate the inspection unit 3.

(Operation of Stocker 1)

The operation of a stocker 1 will be described using FIGS. 1 and 5. Even during which the inspection unit 3 is performing an inspection, the stacker crane 12 moves on the rails 13 to transfer cassettes 10. Although vibrations are generated due to the stacker crane 12 moving on the rails 13 to transfer the cassettes 10, since the primary floor plate 8 on which a housing 2 which includes the stacker crane 12 is placed is independent of the secondary floor plate 9 on which the inspection unit 3 is placed, there occurs no case where the vibrations so generated are transmitted from the primary floor plate 8 directly to the secondary floor plate 9. In addition, since the floor 5 which supports the primary floor plate 8 is independent of the tertiary floor 25 which supports the secondary floor plate 9, there also occurs no case where the vibrations so generated are transmitted from the floor 5 to the tertiary floor 25 to thereby vibrate the inspection unit 3. By this configuration, the transmission of vibrations generated when the stacker crane 12 transfers the cassettes 10 to the inspection unit 3 can more preferably be suppressed, thereby making it possible to allow the inspection unit 3 to inspect wafers more preferably.

Since other features of the third embodiment are similar to those of the second embodiment, the description thereof will be omitted here.

### Fourth Embodiment

Next, referring to FIGS. 1 and 6, a fourth embodiment of the invention will be described below.

(Configuration of Floor of the Embodiment)

The fourth embodiment differs from the first embodiment in that a secondary floor plate 9 on which an inspection unit 3 is placed is, as is shown in FIG. 6, supported by supporting legs 16 which are provided on a vibration control unit 36, which functions as a vibration control unit placed on a floor 5, in such a manner as to erect therefrom.

While vibrations generated due to a stacker crane 12 moving on rails 13 to transfer cassettes 10 are transmitted to a primary floor plate 8, then to a floor 5 via supporting legs 6 and finally to the vibration control unit 36, since the vibration control unit 36 dampens the vibrations so transmitted thereto, the transmission of the vibrations to the secondary floor plate 9 on the vibration control unit 36 and the inspection unit 3 is suppressed. In addition, there occurs no case where the vibrations are transmitted from the primary floor plate 8 directly to the secondary floor plate 9 to thereby vibrate the inspection unit 3.

(Operation of Stocker 1)

The operation of a stocker 1 will be described using FIGS. 1 and 6. Even during which the inspection unit 3 is performing an inspection, the stacker crane 12 moves on the rails 13 to transfer cassettes 10. Although vibrations are generated due to the stacker crane 12 moving on the rails 13 to transfer the cassettes 10, since the primary floor plate 8 on which a housing 2 which includes the stacker crane 12 is placed is independent of the secondary floor plate 9 on which the inspection unit 3 is placed, there occurs no case where the vibrations so generated are transmitted from the primary floor plate 8 directly to the secondary floor plate 9. In addition, since the vibrations transmitted to the floor 5 which supports the primary floor plate 8 are dampened by the vibration control unit 36, the transmission of the vibrations to the secondary floor plate 9 on the vibration control unit 36 and the inspection unit 3 is suppressed, whereby the transmission of vibrations generated when the stacker crane 12 transfers the cassettes 10 to the inspection unit 3 can more preferably be suppressed, thereby making it possible to allow the inspection unit 3 to inspect wafers more preferably.

(Summary of the Embodiment)

As has been described above, in the stoker 1 of the embodiment, the configuration is adopted in which the secondary floor plate 9 is supported by the vibration control unit 36. According to the configuration, since the secondary floor plate 9 on which the inspection unit 3 is placed is supported by the vibration control unit 36, the transmission of vibrations generated when the stacker crane 12 transfers the cassettes 10 to the inspection unit 3 can preferably be suppressed by the vibration control unit 36.

### Fifth Embodiment

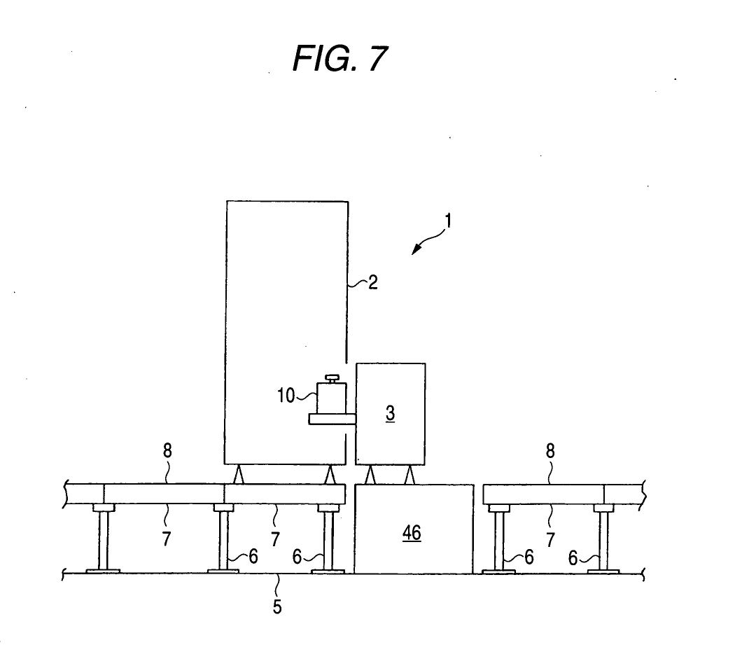

Next, referring to FIGS. 1 and 7, a fifth embodiment of the invention will be described below.

(Configuration of Floor of the Embodiment)

The fifth embodiment differs from the first embodiment in that an inspection unit 3 is, as is shown in FIG. 7, placed on a vibration control unit 46, which functions as a vibration control unit placed on a floor 5. The vibration control unit 46 and a primary floor plate 8 are independent of each other.

Although vibrations generated due to a stacker crane 12 moving on rails 13 to transfer cassettes 10 are transmitted to the primary floor plate 8, then to the floor 5 via supporting legs 6 and finally to the vibration control unit 46, since the vibration control unit 46 dampens the vibrations so transmitted thereto, the transmission of the vibrations to the inspection unit 3 on the vibration control unit 46 is suppressed. In addition, there occurs no case where the vibrations so generated are transmitted from the primary floor plate 8 directly to the vibration control unit 46 to thereby vibrate the inspection unit 3.

(Operation of Stocker 1)

The operation of a stocker 1 will be described using FIGS. 1 and 7. Even during which the inspection unit 3 is performing an inspection, the stacker crane 12 moves on the rails 13 to transfer cassettes 10. Although vibrations are generated due to the stacker crane 12 moving on the rails 13 to transfer the cassettes 10, since the primary floor plate 8 on which a housing 2 which includes the stacker crane 12 is placed is independent of the vibration control unit 46, the transmission of the vibrations to the inspection unit 3 on the vibration control unit 46 is suppressed. In addition, there occurs no case where the vibrations so generated are transmitted from the primary floor plate 8 directly to the vibration control unit 46 to thereby vibrate the inspection unit 3.

(Operation of Stocker)

The operation of a stocker 1 will be described using FIGS. 1 and 7. Even during which the inspection unit 3 is performing an inspection, the stacker crane 12 moves on the rails 13 to transfer the cassettes 10. Although vibrations are generated due to the stacker crane 12 moving on the rails 13 to transfer the cassettes 10, since the primary floor plate 8 on which a housing 2 which includes the stacker crane 12 is placed and the vibration control unit 46 on which the inspection unit 3 is placed are independent of each other, there occurs no case where the vibrations so generated are transmitted from the primary floor plate 8 directly to the vibration control unit 46. In addition, since the vibrations transmitted to the floor 5 which supports the primary floor plate 8 are dampened by the vibration control unit 46, the transmission of the vibrations to the inspection unit 3 on the vibration control unit 46 is suppressed, whereby the transmission of the vibrations generated when the stacker crane 12 transfers the cassettes 10 to the inspection unit 3 can preferably be suppressed, thereby making it possible to allow the inspection unit 3 to perform preferably inspections on wafers.

(Summary of the Embodiment)

As has been described above, the stocker 1 of the embodiment is configured to include shelves 11 which store the cassettes 10 each accommodating therein a wafer, the inspection unit 3 for performing the manufacturing operation (inspection) on the wafers within the cassettes 10, and the stacker crane 12 for transferring the cassettes 10 between the shelves 11 and the inspection unit 3, and the shelves 11 and the stacker crane 12 are placed on the primary floor plate 8, while the inspection unit 3 is placed on the vibration control unit 46 which is independent of the primary floor plate 8.

According to the configuration that has been described above, since the inspection unit 3 is placed on the vibration control unit 46 which is independent of the primary floor plate 8 on which the shelves 11 and the stacker crane 12 are placed, the transmission of vibrations generated when the stacker crane 12 transfers the cassettes 10 to the inspection unit 3 can be suppressed by the vibration control unit 46, thereby making it possible to allow the inspection unit 3 to preferably perform the processing (inspection) of the wafers.

The present invention also provides a floor system adapted to arrange, above a floor 5, a housing 2 that can store plural cassettes 10, each capable of storing plural articles, an article processor 3 for processing each of the articles, and a stacker crane 12 for transferring each of the cassettes between the housing and the article processor, the floor system comprising: a first floor component that is located between the floor 5 and each of the housing 2 and the stacker crane 12; and a second floor component that is adjacent to but separate from the first floor component and that is located between the floor 5 and the article processor 3.

In the first to fifth embodiments, as shown in FIGS. 3 to 7, the first floor component includes: plural first supporting legs 6 provided on and erecting from the floor 5; and at least one first floor plate 8 supported by the first supporting legs, wherein the at least one first floor plate 8 defines a first surface where the housing 2 and the stacker crane 12 are disposed.

In the first embodiment, as shown in FIG. 3, the second floor component includes: plural second supporting legs 6 that are different from the first supporting legs and that are provided on and erect from the floor 5; and at least one second floor plate 9 that is different from the first floor plate and that is supported by the second supporting legs, wherein the at least one second floor plate 9 defines a second surface where the article processor 3 is disposed.

In the second embodiment, as shown in FIG. 4, the second floor components include: a secondary floor 15 that is located above the floor 5 and that is independent of the floor 5; plural second supporting legs 16 that are different from the first supporting legs and that are provided on and erect from the secondary floor 15; and at least one second floor plate 9 that is different from the first floor plate 8 and that is supported by the second supporting legs, wherein the at least one second floor plate 9 defines a second surface where the article processor 3 is disposed.

In the third embodiment, as shown in FIG. 5, the second floor component includes: a block 26 that is provided on a tertiary floor 25 located below the floor 5; plural second supporting legs 16 that are different from the first supporting legs and that are provided on and erect from the block 26; and at least one second floor plate 9 that is different from the first floor plate 8 and that is supported by the second supporting legs, wherein the at least one second floor plate 9 defines a second surface where the article processor 3 is disposed.

In the fourth embodiment, as shown in FIG. 6, the second floor component includes: an anti-vibration unit 36 provided on the floor 5; plural second supporting legs 16 that are different from the first supporting legs and that are provided on and erect from the anti-vibration unit 36; and at least one second floor plate 9 that is different from the first floor plate 8 and that is supported by the second supporting legs, wherein the at least one second floor plate 9 defines a second surface where the article processor 3 is disposed.

In the fifth embodiment, as shown in FIG. 7, the second floor component includes: an anti-vibration unit 46 provided on the floor 5, wherein the anti-vibration unit 46 defines a second surface where the article processor 3 is disposed.

(Modified Examples made to the Embodiments)

In addition, while the invention has been described heretofore based on the preferred embodiments, the invention can be modified without departing from the spirit and scope thereof. Namely, a configuration may be adopted in which a primary floor plate 8 on which a housing 2 is placed is supported by a vibration control unit. In the embodiments shown in FIGS. 3, 6, 7, since the vibrations generated by the stacker crane 12 in the housing 2 are dampened by the vibration control unit for transmission to the floor 5, the transmission of vibrations to an inspection unit 3 can more preferably be suppressed.

What is claimed is:

1. A stocker comprising:
storing means for storing therein accommodating means which accommodates therein an accommodated article;
accommodated article processing means for performing a manufacturing operation on the accommodated article within the accommodating means; and
transfer means for transferring the accommodating means between the storing means and the accommodated article processing means, wherein
the storing means and the transfer means are placed on a primary floor plate, and wherein
the accommodated article processing means is placed on a secondary floor plate which is independent of the primary floor plate.

2. A stocker as set forth in claim 1, wherein
the primary floor plate is supported by a primary floor, and wherein
the secondary floor plate is supported by a secondary floor which is independent of the primary floor.

3. A stocker as set forth in claim 1, wherein the secondary floor plate is supported by vibration control means.

4. A stocker comprising:
storing means for storing therein accommodating means which accommodates therein an accommodated article;
accommodated article processing means for performing a manufacturing operation on the accommodated article within the accommodating means; and
transfer means for transferring the accommodating means between the storing means and the accommodated article processing means, wherein
the storing means and the transfer means are placed on a floor plate, and wherein
the accommodated article processing means is placed on vibration control means which is independent of the floor plate.

5. A floor system adapted to arrange, above a floor, a housing that can store plural cassettes, each capable of storing plural articles, an article processor for processing each of the articles, and a stacker crane for transferring each of the cassettes between the housing and the article processor, the floor system comprising:
a first floor component that is located between the floor and each of the housing and the stacker crane; and
a second floor component that is adjacent to but separate from the first floor component and that is located between the floor and the article processor.

6. A floor system according to claim 5,
wherein the first floor component includes:
plural first supporting legs provided on and erecting from the floor; and
at least one first floor plate supported by the first supporting legs,
wherein the at least one first floor plate defines a first surface where the housing and the stacker crane are disposed.

7. A floor system according to claim 6,
wherein the second floor component includes:
plural second supporting legs that are different from the first supporting legs and that are provided on and erect from the floor; and
at least one second floor plate that is different from the first floor plate and that is supported by the second supporting legs,
wherein the at least one second floor plate defines a second surface where the article processor is disposed.

8. A floor system according to claim 6,
wherein the second floor component includes:
a secondary floor that is located above the floor and that is independent of the floor;
plural second supporting legs that are different from the first supporting legs and that are provided on and erect from the secondary floor; and
at least one second floor plate that is different from the first floor plate and that is supported by the second supporting legs,
wherein the at least one second floor plate defines a second surface where the article processor is disposed.

9. A floor system according to claim 6,
wherein the second floor component includes:
a block that is provided on a tertiary floor located below the floor;
plural second supporting legs that are different from the first supporting legs and that are provided on and erect from the block; and
at least one second floor plate that is different from the first floor plate and that is supported by the second supporting legs,
wherein the at least one second floor plate defines a second surface where the article processor is disposed.

10. A floor system according to claim 6,
wherein the second floor component includes:
an anti-vibration unit provided on the floor;
plural second supporting legs that are different from the first supporting legs and that are provided on and erect from the anti-vibration unit; and
at least one second floor plate that is different from the first floor plate and that is supported by the second supporting legs,
wherein the at least one second floor plate defines a second surface where the article processor is disposed.

11. A floor system according to claim 6,
wherein the second floor component includes:
an anti-vibration unit provided on the floor,
wherein the anti-vibration unit defines a second surface where the article processor is disposed.
